(19) United States
(12) Patent Application Publication
(10) Pub. No.: US 2018/0170728 A1
(43) Pub. Date: Jun. 21, 2018

(54) WHEELED CABINET HAVING A TIRE LIFTING DEVICE

(71) Applicants: Kung-Cheng Chen, Taichung City (TW); Lung-Chuan Huang, Taichung City (TW)

(72) Inventors: Kung-Cheng Chen, Taichung City (TW); Lung-Chuan Huang, Taichung City (TW)

(73) Assignee: E-MAKE Co.,Ltd., Taichung City (TW)

(21) Appl. No.: 15/384,662

(22) Filed: Dec. 20, 2016

(51) Int. Cl. B66F 3/24; B62B 3/00; B60B 29/00

(52) U.S. Cl. CPC B66F 3/247; B62B 3/005; B62B 3/004; B60B 2900/521; B60B 29/002; B60B 2340/34; B60B 2340/36; B60B 29/001

(57) ABSTRACT

A wheeled cabinet includes a container including compartments, a rear handle, drawers, and a storage between the drawers and a base; a pneumatic assembly including an inlet, connectors, a pneumatic cylinder on the base, a piston rod configured to move alternately upward and downward relative to the cylinder, and a controller for activating the cylinder; a lifting assembly including two opposite rails upwardly disposed on two sides of the base respectively, and an inverted U-shaped frame member slidably disposed on the rails and having an underside of a top secured to the piston rod; and a tire support assembly including a support secured to the frame member, two slides on two sides of the support respectively, a sliding tray secured to the slides, a slot on an inner surface of the tray, a moveable tab in the slot, and two rollers on two sides of the tray respectively.

### BACKGROUND OF THE INVENTION

### 1. Field of the Invention

The invention relates to cabinets and more particularly to a wheeled cabinet having a pneumatic tire lifting device.

### 2. Description of Related Art

Conventionally, cabinets and hydraulic jacks are equipment of an automobile repair shop. In a tire replacement operation, a technician may operate a hydraulic jack to lift a car, remove the worn tire at one end of an axle, and install a new tire. It is known that a cabinet for tools is required in the tire replacement operation. It is also known that aligning the hub of the new tire with the axle is mainly done manually.

It is thus desirable to provide a wheeled cabinet having a tire lifting device to facilitate the tire replacement operation.

### SUMMARY OF THE INVENTION

It is therefore one object of the invention to provide a cabinet comprising a container including a plurality of compartments on a top, a handle on a rear end, a plurality of drawers under the handle, a base, a storage between the drawers and the base, two front wheels disposed under the base, and two rear wheels disposed under the base; a pneumatic assembly including an inlet, a plurality of connectors, a pneumatic cylinder disposed on the base and being in fluid communication with one of the connectors, a piston rod configured to move alternately upward and downward relative to the pneumatic cylinder, and a controller for activating the pneumatic cylinder or not; a lifting assembly including two opposite rails upwardly disposed on two sides of the base respectively, and an inverted U-shaped frame member slidably disposed on the rails and having an underside of a top secured to the piston rod; and a tire support assembly including a support secured to a front end of the frame member, two slides disposed on two sides of the support respectively, a tray slidably secured to the slides and configured to extend or retract relative to the support, a slot disposed on an inner surface of one side of the tray, a finger tab moveably disposed in the slot, and two rollers disposed on tops of two sides of the tray respectively.

The above and other objects, features and advantages of the invention will become apparent from the following detailed description taken with the accompanying drawings.

### BRIEF DESCRIPTION OF THE DRAWINGS

FIG. 1 is a perspective view of a wheeled cabinet according to the invention;

FIG. 2 is another perspective view of the wheeled cabinet;

FIG. 2A is similar to FIG. 2 showing the lifted frame member and the open storage;

FIG. 3 is a side elevation of FIG. 1;

FIG. 4 is another perspective view of FIG. 2A;

FIG. 4A is similar to FIG. 4 showing a tire positioned on the tray;

FIG. 5 is a side elevation of FIG. 4;

FIG. 5A is a side elevation of FIG. 4A;

FIG. 6 is similar to FIG. 4 showing the pulled out tray;

FIG. 7 is view similar to FIG. 5A showing the pulled out tray; and

FIG. 8 is a front view of FIG. 6.

### DETAILED DESCRIPTION OF THE INVENTION

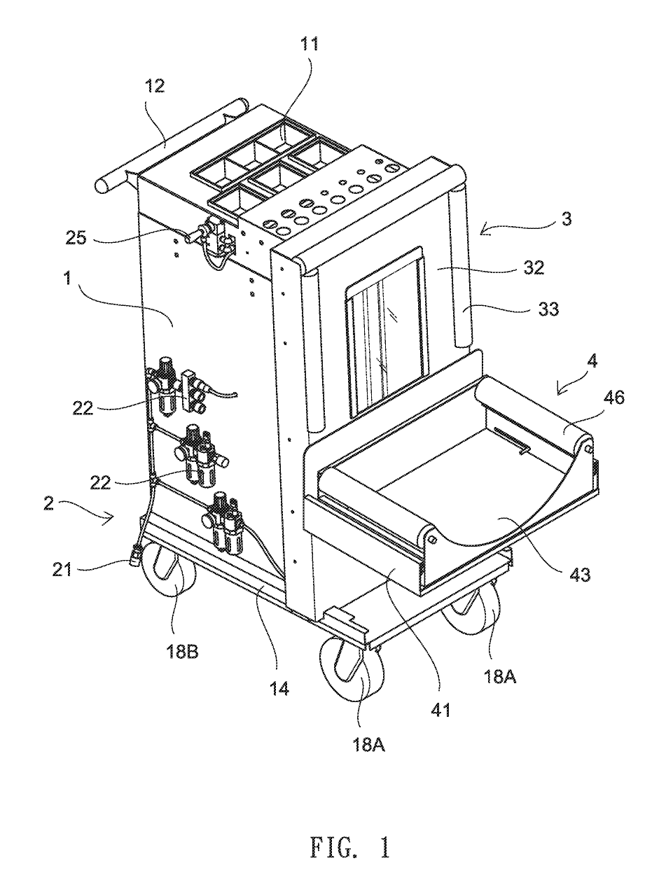

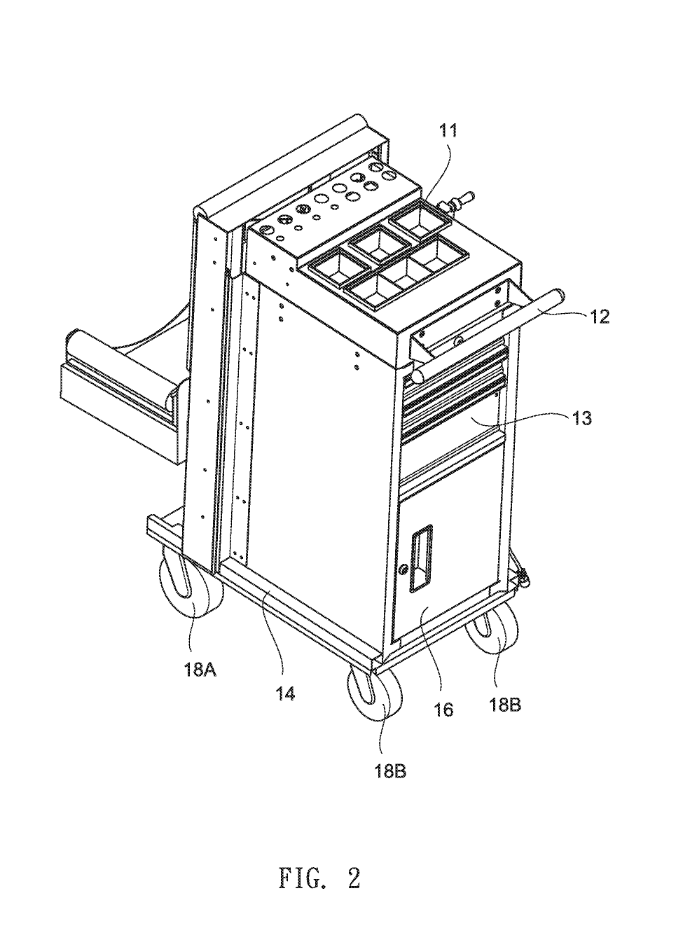

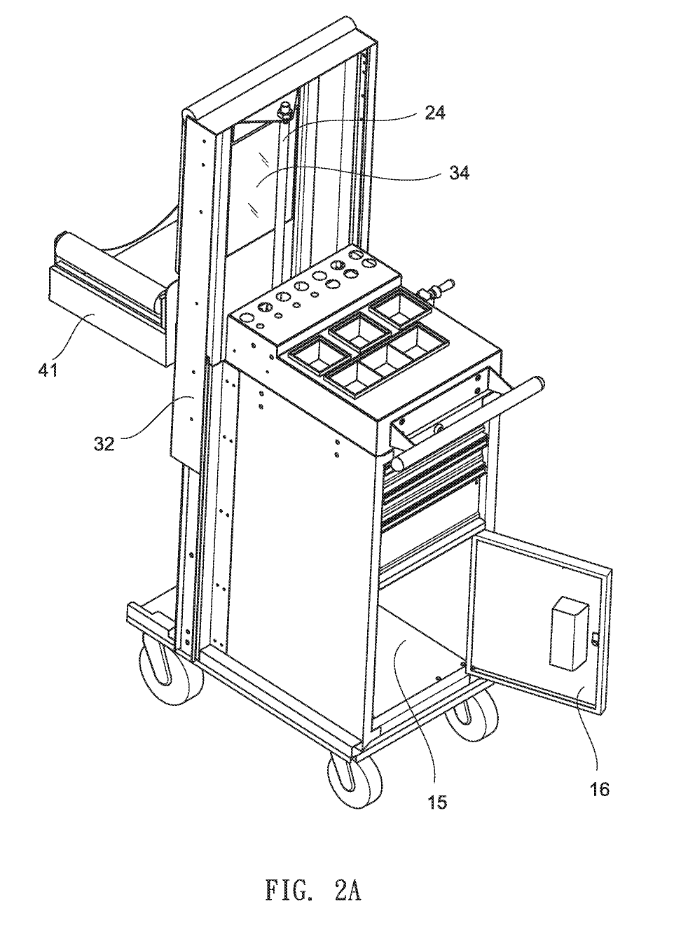

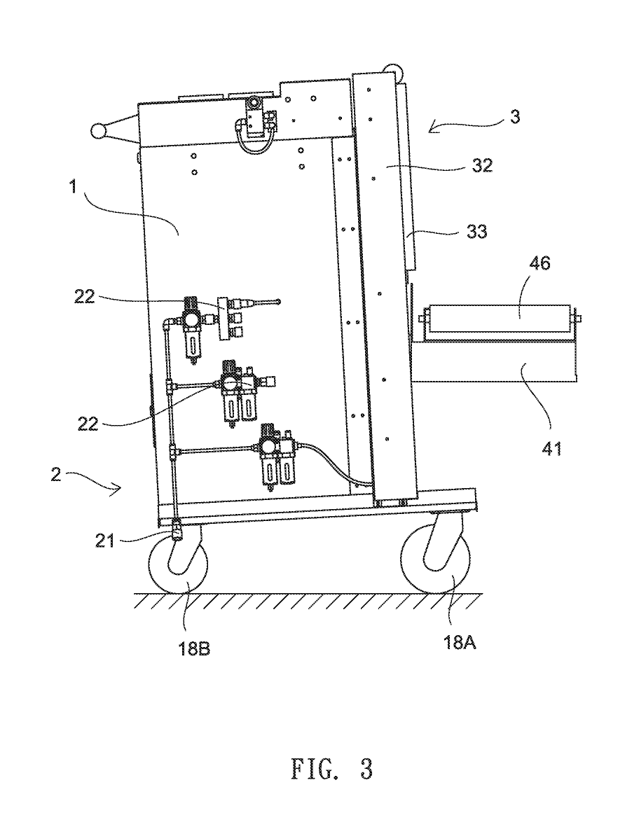

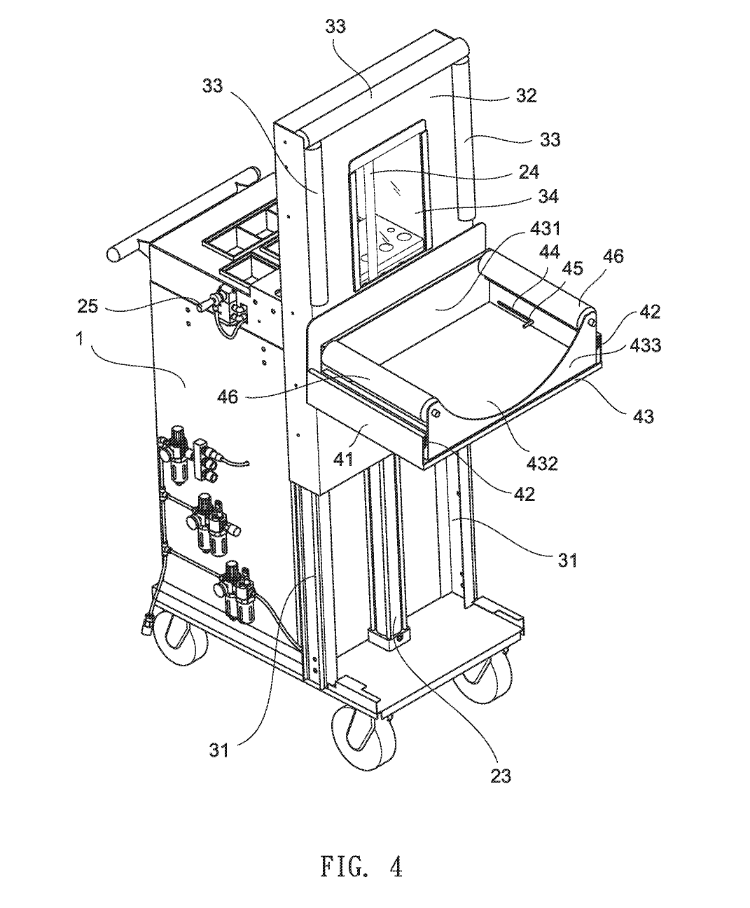

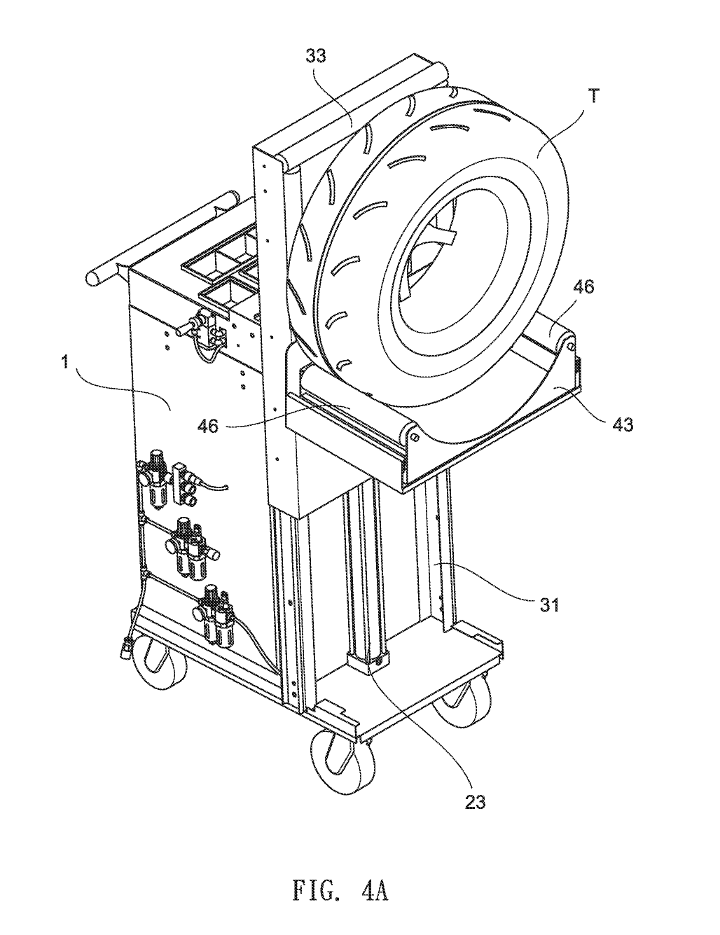

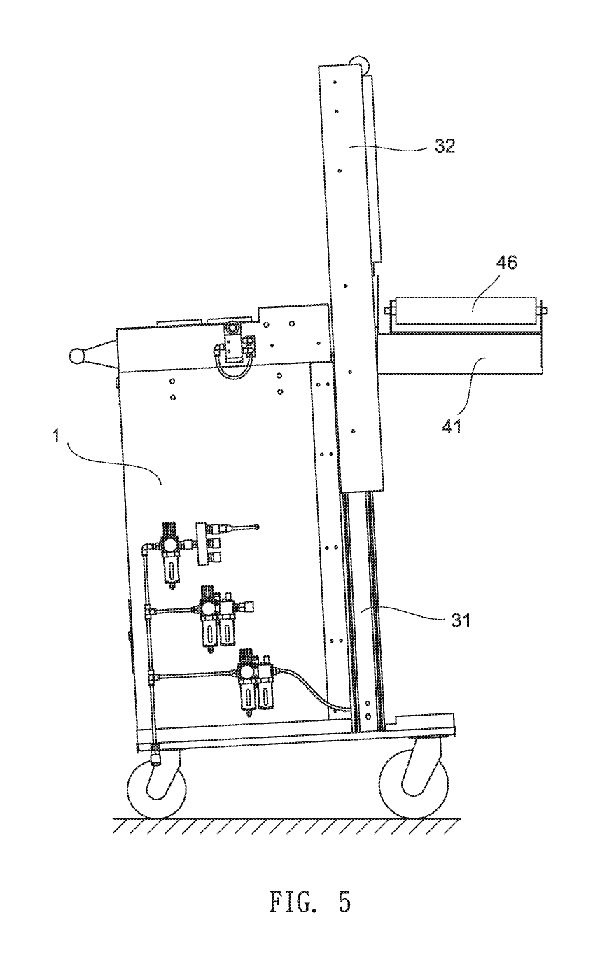

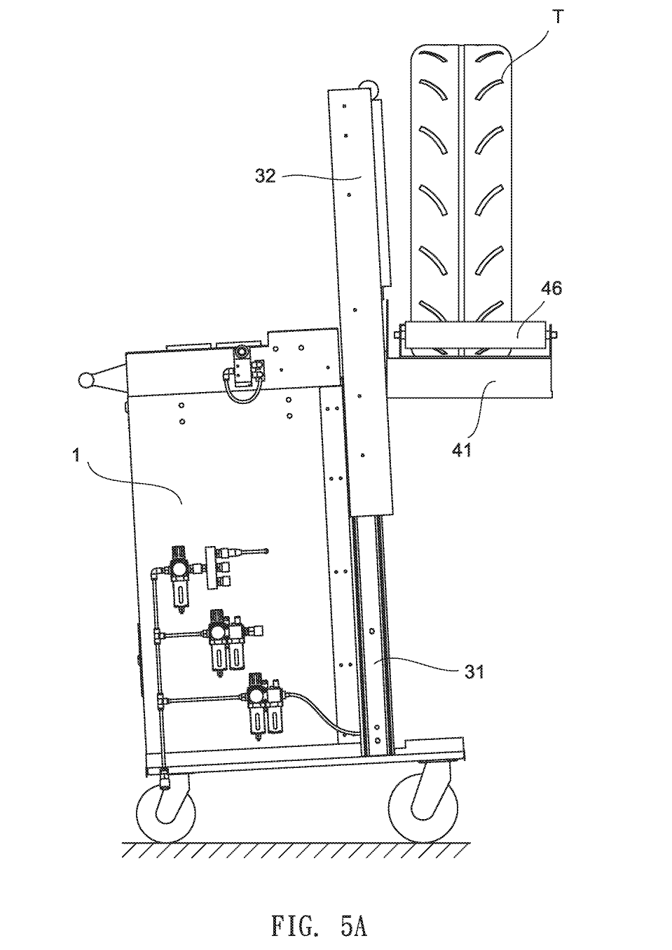

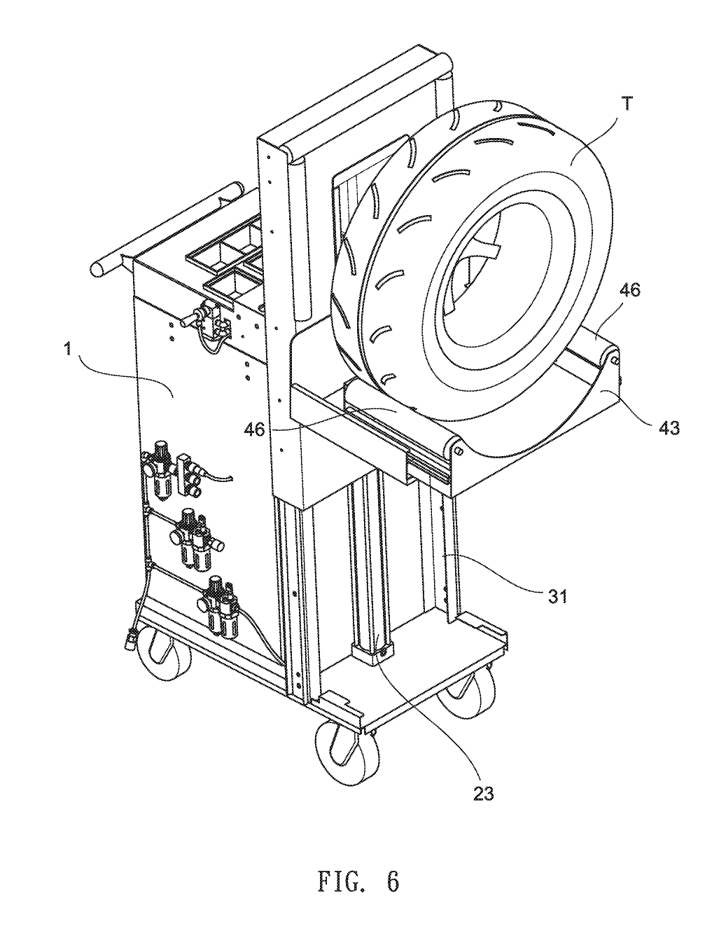

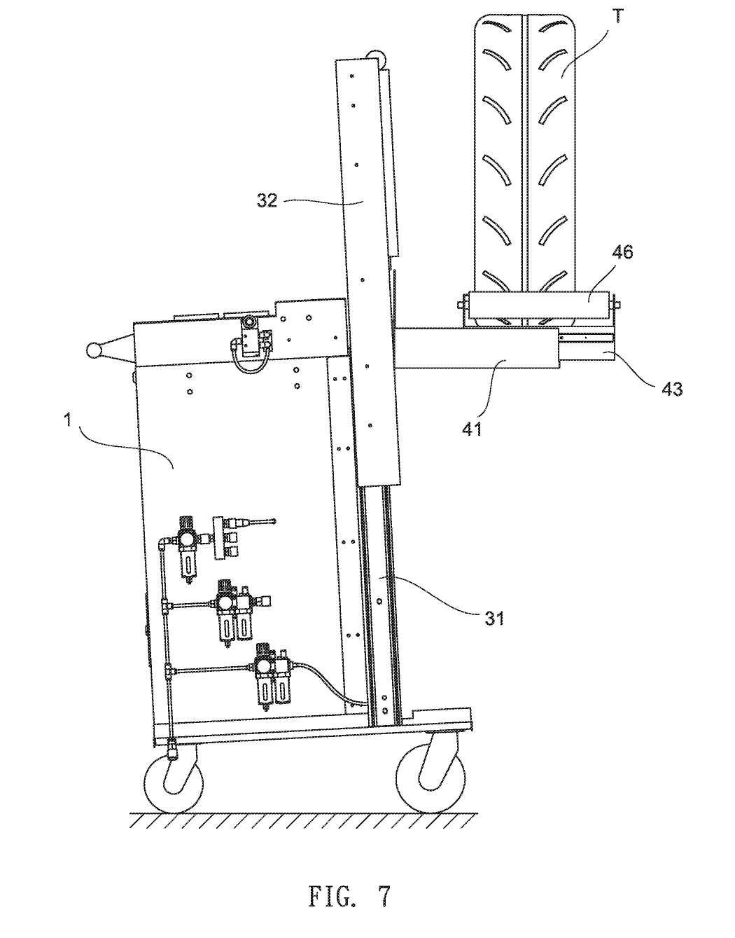

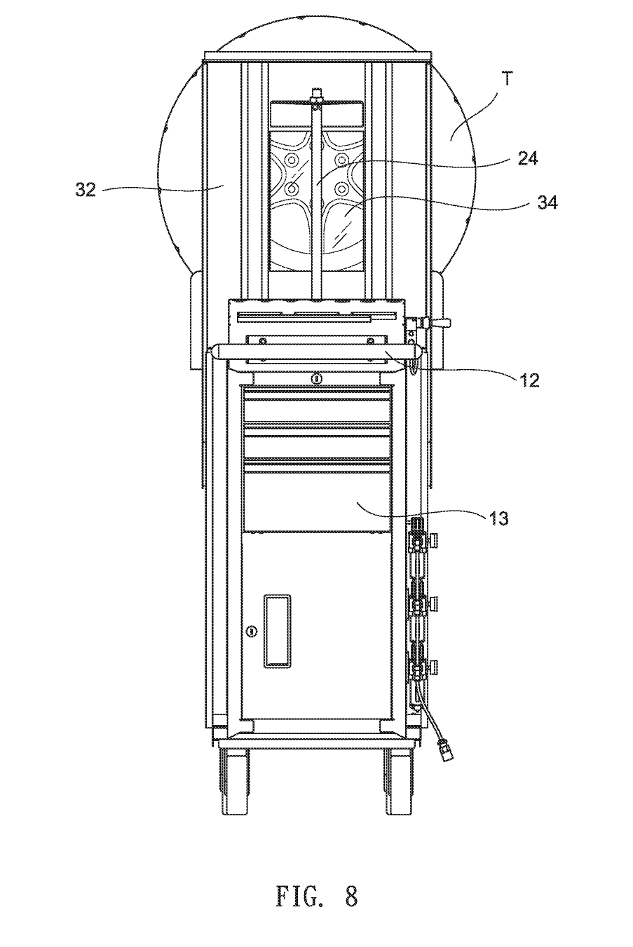

Referring to FIGS. 1 to 8, a wheeled cabinet in accordance with the invention comprises the following components as discussed in detail below.

A container 1 includes a plurality of compartments 11 on a top, a handle 12 on a rear end, a plurality of drawers 13 under the handle 12, a base 14, a storage 15 between the drawers 13 and the base 14, a door 16 hingedly mounted on the storage 15, two large front wheels 18A mounted under the base 14, and two small rear wheels 18B mounted under the base 14.

A pneumatic assembly 2 includes an inlet 21 extending out of the container 1 to connected to an air compressor (not shown) via a line (not shown), a plurality of connectors 22 for connecting to different pneumatic tools (not shown) respectively, a pneumatic cylinder 23 mounted on the base 14 and in fluid communication with the connector 22, a piston rod 24 connected to a piston (not shown) in the cylinder 23 so as to move alternately upward and downward, and a controller 25 mounted on one side of the top of the container 1 and configured to activate the cylinder 23 or not.

A lifting assembly 3 includes two opposite grooved rails 31 upwardly mounted on two sides of the base 14 respectively, an inverted U-shaped frame member 32 slidably mounted on the grooved rails 31 and having an underside of a top secured to a top end of the piston rod 24 so that the frame member 32 and the piston rod 24 together may lift or lower, a plurality of (e.g., three) pads 33 provided on three edges of an upper portion of the frame member 32 respectively, and a window 34 mounted among the pads 33.

A tire support assembly 4 includes a support 41 secured to a front end of the frame member 32 and under the pads 33, two slides 42 mounted on two sides of the support 41 respectively, a tray 43 having a rear wall 431, a concave bottom 432, and a concave front wall 433, the tray 43 slidably secured to the slides 42 and configured to extend or retract relative to the support 41, a slot 44 provided on an inner surface of one side of the tray 43, a finger tab 45 moveably disposed in the slot 44, and two rollers 46 provided on tops of two sides of the tray 43 respectively.

The invention can be applied in an automobile repair shop. In a tire replacement operation, a technician may operate a hydraulic jack to lift a car and remove the worn tire at one end of an axle. Next, the technician place a tire T on a rear portion of the tray 43 between the finger tab 45 and the rear wall 431. Next, the technician may rearward move the finger tab 45 to position the tire T. Next, the technician may hold and push the handle 12 to move the container 1 near the car. Next the technician may operate the controller 25 to direct compressed air from the air compressor to the cylinder 23 via the connector 22. And in turn, the compressed air pushes the piston to lift or lower the piston rod 24. The technician can see the operation through the window 34. The technician may stop the lifting or lowering operation when the hub of the tire T is aligned with the axle. Next, the technician may extend the tray 43 to increase a space between the tray 43 and the frame member 32. The space should be large enough to allow the technician to drive screws through the tire T and the axle to install the tire T on the axle.

The front wheels 18A are larger than the rear wheels 18B for the purpose of increasing stability of the lifting operation.

The tray 43 maintains at a horizontal position in the lifting or lowering operation.

While the invention has been described in terms of preferred embodiments, those skilled in the art will recognize that the invention can be practiced with modifications within the spirit and scope of the appended claims.

1-6. (canceled)

7. A cabinet comprising:
a container including a plurality of compartments on a top, a handle on a rear end, a plurality of drawers under the handle, a base, a storage between the drawers and the base, two front wheels disposed under the base, and two rear wheels disposed under the base;
a pneumatic assembly including an inlet, a plurality of connectors, a pneumatic cylinder disposed on the base and being in fluid communication with one of the connectors, a piston rod configured to move alternately upward and downward relative to the pneumatic cylinder, and a controller for activating the pneumatic cylinder or not;
a lifting assembly including two opposite rails upwardly disposed on two sides of the base respectively, and an inverted U-shaped frame member slidably disposed on the rails and having an underside of a top secured to the piston rod;
a tire support assembly including a support secured to a front end of the frame member, two slides disposed on two sides of the support respectively, a tray slidably secured to the slides and configured to extend or retract relative to the support, a slot disposed on an inner surface of one side of the tray, a finger tab moveably disposed in the slot, and two rollers disposed on tops of two sides of the tray respectively;
a plurality of pads disposed on three edges of an upper portion of the frame member respectively; and
a door hingedly disposed on the storage;
wherein in response to moving the piston rod alternately upward and downward relative to the pneumatic cylinder, both the frame member and the finger tab on either side of the tray that positions the tire move;
wherein a manual operation of the finger tab moves the tire toward a rear wall of the tray;
wherein the front wheels are larger than the rear wheels;
wherein the tray includes a rear wall, a concave bottom, and a concave front wall; and
wherein the lifting assembly further comprises a window mounted among the pads.
